(19) United States
(12) Patent Application Publication
(10) Pub. No.: US 2025/0323000 A1
(43) Pub. Date: Oct. 16, 2025

(54) OPERATION MECHANISM FOR SWITCHING DEVICE AND SWITCHING DEVICE ASSEMBLY

(71) Applicant: Schneider Electric Industries SAS, Rueil-Malmaison (FR)

(72) Inventors: Xiaoqiang Li, Shanghai (CN); Shunxian Mao, Shanghai (CN); Zhen Li, Shanghai (CN); Zhenzhong Liu, Shanghai (CN)

(73) Assignee: Schneider Electric Industries SAS, Rueil-Malmaison (FR)

(21) Appl. No.: 19/178,265

(22) Filed: Apr. 14, 2025

(30) Foreign Application Priority Data
Apr. 15, 2024 (CN) 2024104464634

(51) Int. Cl. H01H 21/22; H01H 21/36

(52) U.S. Cl. CPC H01H 21/22; H01H 21/36

(57) ABSTRACT

An operation mechanism for a switching device and a switching device assembly are provided. The operation mechanism includes: a housing; an operation handle, a first driving member, a second driving member, when the switching device performs a tripping operation under an action of an internal electromagnet, in response to that the operation handle is blocked and not able to rotate, the second driving member rotates in the first direction to switch the switching device from the closed state to the open state, the protrusion move relatively in the groove, and a distance between the protrusion and the second end of the groove is configured such that the protrusion will not prevent the second driving member from rotating in the first direction to switch the switching device to the open state.

The present disclosure claims the priority and benefits of the Chinese Patent Applications No. 2024104464634, which was filed on Apr. 15, 2024, the disclosure of which is incorporated herein by reference in its entirety as part of the present disclosure.

### TECHNICAL FIELD

The present disclosure relates to an operation mechanism for a switching device and a switching device assembly.

### BACKGROUND

At present, the operation mechanisms that drive disconnectors or circuit breakers in the market are mostly controlled manually. The external handle drives the closing and opening operations of the internal contact system, and the handle also has the state indication function. A small number of automatic operation mechanisms can be realized by adding a driving module, but this driving mode is generally directly driven on the handle, and the state indication function of opening and closing needs an additional device to realize.

Although some systems in the prior art can realize bidirectional operation, these systems often cannot guarantee the free tripping function of switching device.

### SUMMARY

In order to overcome the abovementioned problems, an operation mechanism for a switching device is provided, the operation mechanism is installed on the switching device, the operation mechanism includes: a housing; an operation handle, rotatably installed on the housing, being capable of rotating between a closed position and an open position and indicating the closed position and the open position; a first driving member, rotatably installed on the housing, fixedly connected to the operation handle and being capable of rotating together with the operation handle; a second driving member, rotatably installed on the housing, operatively connected to the first driving member on the one hand and operatively connected to the switching device on the other hand,
the first driving member includes a body and a protrusion extending from the body toward the second driving member, and the second driving member includes a groove, the protrusion of the first driving member extends into the groove,
the groove includes a first end and a second end, and the first end of the groove is located downstream of the second end relative to a first direction, the first direction corresponds to a rotation direction of the second driving member when the switching device is switched from a closed state to an open state,
when the switching device performs a tripping operation under an action of an internal electromagnet, in response to that the operation handle is blocked and not able to rotate, the second driving member rotates in the first direction to switch the switching device from the closed state to the open state, the protrusion move relatively in the groove, and a distance between the protrusion and the second end of the groove is configured such that the protrusion will not prevent the second driving member from rotating in the first direction to switch the switching device to the open state.

Advantageously, in the closed state of the switching device, when the operation handle is in the closed position, the protrusion of the first driving member is configured not to abut against the first end and the second end of the groove,
the operation mechanism further includes an elastic transmission member connected between the first driving member and the second driving member, when the switching device performing an opening operation, the second driving member rotates in the first direction, and a rotating force is transmitted to the first driving member through the elastic transmission member, so that the first driving member also rotates in the first direction, and the operation handle rotates in the first direction toward the open position

Advantageously, the operation mechanism further includes an operation handle spring, one end of the operation handle spring is operatively connected to the operation handle and the other end of the operation handle spring is fixed to the housing, and the operation handle spring is configured to pass through a dead center position before the second driving member rotates in place when the operation handle is driven by the second driving member to rotate from the closed position to the open position, so that the first driving member continues to rotate in the first direction, so as to allow the protrusion to abut against the first end of the groove.

Advantageously, in open state of the switching device, when the operation handle is in the open position, the protrusion abuts against the first end, and when the switching device performs a closing operation, the second driving member rotates in a second direction opposite to the first direction, and the first end pushes the protrusion and further pushes the first driving member to rotate in the second direction, so that the operation handle rotates in the second direction towards the closed position,
when the operation handle is driven by the second driving member to rotate from the open position to the closed position, before the second driving member rotates in place, the operation handle spring passes through a dead center position, so that the first driving member continues to rotate in the second direction, and the protrusion is separated from abutment with the first end of the groove.

Advantageously, in the closed state of the switching device, when the operation handle is in the closed position, when the operation handle rotates from the closed position to the open position under an action of an external force, the first driving member rotates by a predetermined angle in the first direction, so that the protrusion abuts against the first end of the groove, thereby driving the second driving member to rotate in the first direction.

Advantageously, the operation mechanism further includes a sensor arranged on the housing,
in the open state of the switching device, when the operation handle is in the open position, when the operation handle rotates from the open position to the closed position under an action of an external force, the first driving member rotates to the closed position in a second direction opposite to the first direction, a part of the operation handle triggers the sensor, so that the sensor sends a closing signal to the internal electromagnet of the switching device, thereby switching the switching device from the open state to the closed state.

Advantageously, the body of the first driving member is in the form of a disk, the second driving member is in the form of a disk,
the protrusion includes a first protrusion part and a second protrusion part, the first protrusion part and the second protrusion part are arranged along a longitudinal direction, and a size of the first protrusion part in a direction perpendicular to the longitudinal direction is greater than a size of the second protrusion part in the direction perpendicular to the longitudinal direction,
the operation handle is configured to be movable in the longitudinal direction between a first position and a second position; in the first position, the first protrusion part of the first driving member is away from the groove of the second driving member, in the second position, the first protrusion part of the first driving member is close to the groove of the second driving member.

Advantageously, the groove includes a first groove part and a second groove part which are communicated with each other, the first groove part is located at a side of the first end and the second groove part is located at a side of the second end, a size of the first groove part is configured to accommodate the first protrusion part and the second protrusion part, a size of the second groove part is configured to accommodate the second protrusion part but not the first protrusion part, and a joint is formed between the first groove part and the second groove part.
in the first position of the operation handle, the second protrusion part can be accommodated in the first groove part and the second groove part,
in the second position of the operation handle, the first protrusion part can be accommodated in the first groove part.

Advantageously, in the closed state of the switching device, when the operation handle is in the closed position, the operation handle is in the first position, and the second protrusion part is accommodated in the first groove part and spaced apart from the first end and the second end,
when the switching device performs a tripping operation under the action of the internal electromagnet, in response to that the operation handle is blocked and not able to rotate, the second driving member rotates in the first direction to switch the switching device from the closed state to the open state, and the second protrusion part of the first driving member relatively moves from the first groove part to the second groove part.

Advantageously, in the open state of the switching device, when the operation handle is in the open position, the second protrusion part abuts against the first end of the groove, and when the operation handle rotates from the open position to the closed position under an action of an external force, the operation handle moves from the first position to the second position, so that the first protrusion part is accommodated in the first groove part, with a rotation of the first driving member in the second direction, the first protrusion part abuts against the joint between the first groove part and the second groove part, so as to push the second driving member to rotate in the second direction, so as to switch the switching device from the open state to the closed state, after the operation handle rotates to the closed position, the operation handle moves from the second position to the first position.

Advantageously, the operation mechanism further includes a return spring arranged between the first driving member and the second driving member, and when the operation handle moves from the first position to the second position, the return spring is compressed to store energy, so as to return the operation handle from the second position to the first position.

Advantageously, the sensor is any one selected from the group consisting of a microswitch, a Hall sensor and a grating sensor.

The present disclosure further provides an operation mechanism for a switching device, the operation mechanism is installed on the switching device, the operation mechanism includes: a housing; an operation handle, rotatably installed on the housing, being capable of rotating between a closed position and an open position and indicating the closed position and the open position; a first driving member, rotatably installed on the housing, fixedly connected to the operation handle and being capable of rotating together with the operation handle; a second driving member, rotatably installed on the housing, operatively connected to the first driving member on the one hand and operatively connected to the switching device on the other hand,
the first driving member includes a body and a protrusion extending from the body toward the second driving member, and the second driving member includes a groove, the protrusion of the first driving member extends into the groove,
the groove includes a first end and a second end, and the first end of the groove is located downstream of the second end relative to a first direction, the first direction corresponds to a rotation direction of the second driving member when the switching device is switched from the closed state to the open state,
in a closed state of the switching device, when the operation handle is in the closed position, the protrusion of the first driving member is arranged to be spaced apart from the first end of the groove,
in a closed state of the switching device, when the operation handle is in the closed position when the operation handle rotates from the closed position to the open position under an action of an external force, the first driving member rotates by a predetermined angle in the first direction, so that the protrusion abuts against the first end of the groove, and then the second driving member is driven to rotate in the first direction, so as to switch the switching device from the closed state to the open state.

Advantageously, in the open state of the switching device, when the operation handle is in the open position, the protrusion of the first driving member is arranged to be spaced apart from the second end of the groove,
in the open state of the switching device, when the operation handle is in the open position, when the operation handle rotates from the open position to the closed position under the action of the external force, the first driving member rotates by a predetermined angle in a second direction opposite to the first direction, so that the protrusion is able to drive the second driving member to rotate in the second direction, so as to switch the switching device from the open state to the closed state.

The present disclosure further provides a switching device assembly, which is characterized in that, the switching device assembly includes a switching device and the abovementioned operation mechanism, and the operation mechanism is installed on the switching device.

### BRIEF DESCRIPTION OF DRAWINGS

The above and other features and advantages of exemplary embodiments of the present disclosure will become more apparent from the following detailed description taken in conjunction with the accompanying drawings, which are for illustrative purposes only and are not intended to limit the scope of the present disclosure in any way, among them:

FIG. 1 shows a schematic diagram of a switching device assembly according to the present disclosure, in which the switching device assembly includes an operation mechanism of a first embodiment, in this case, the switching device is in a closed state and the operation handle is in a closed position.

FIG. 2 shows an enlarged view of part A of FIG. 1.

FIG. 3 shows a schematic diagram of a switching device assembly according to the present disclosure, in which the switching device assembly includes an operation mechanism of a first embodiment, in this case, the switching device is in an open state and the operation handle is in an open position.

FIG. 4 shows an enlarged view of part A of FIG. 3.

FIG. 5 shows a schematic diagram of a switching device assembly according to the present disclosure, in which the switching device assembly includes an operation mechanism of a second embodiment, in this case, the switching device is in a closed state and the operation handle is in a closed position.

FIG. 6 shows an enlarged view of part B of FIG. 5.

FIG. 7 shows a schematic diagram of a switching device assembly according to the present disclosure, in which the switching device assembly includes an operation mechanism of a second embodiment, in this case, the switching device is in an open state and the operation handle is in an open position.

FIG. 8 shows an enlarged view of part B of FIG. 7.

FIG. 9 shows a schematic diagram of a switching device assembly according to the present disclosure, in which the switching device assembly includes an operation mechanism of the second embodiment, in this case, the switching device is in an open state, but the operation handle is in a closed position.

FIG. 10 shows an enlarged view of part B of FIG. 9.

FIG. 11 shows an elastic transmission member connected between a first driving member and a second driving member.

FIG. 12 shows a schematic diagram of a switching device assembly according to the present disclosure, in which the switching device assembly includes an operation mechanism of a third embodiment, in this case, the switching device is in a closed state, the operation handle is in the closed position, and the operation handle is in the first position.

FIG. 13 shows an enlarged view of part C of FIG. 12.

FIG. 14 shows a schematic diagram of a switching device assembly according to the present disclosure, in which the switching device assembly includes an operation mechanism according to a third embodiment, in this case, the switching device is in an open state, the operation handle is in an open position, and the operation handle is in a first position.

FIG. 15 shows an enlarged view of part C of FIG. 14.

FIG. 16 shows a schematic diagram of a switching device assembly according to the present disclosure, in which the switching device assembly includes an operation mechanism according to a third embodiment, in this case, the switching device is in an open state, the operation handle is in an open position, and the operation handle is in a second position.

FIG. 17 shows an enlarged view of part C of FIG. 15.

FIG. 18 shows a schematic diagram of a switching device assembly according to the present disclosure, in which the switching device assembly includes an operation mechanism of a third embodiment, in this case, the switching device is in a closed state, the operation handle does not reach the closed position, and the operation handle is in a second position.

FIG. 19 shows an enlarged view of part C of FIG. 18.

FIG. 20 shows a perspective view of an operation handle of an operation mechanism according to a third embodiment of the present disclosure.

FIG. 21 shows a perspective view of a second driving member of an operation mechanism according to a third embodiment of the present disclosure.

FIG. 22 shows a return spring connected between the first driving member and the second driving member.

### DETAILED DESCRIPTION

In order to make the purpose, technical details and advantages of the technical solution of the present disclosure more clear, the technical solution of the embodiment of the present disclosure will be described clearly and completely with the accompanying drawings of specific embodiments of the present disclosure. Like reference numerals in the drawings represent like parts. It should be noted that the described embodiment is a part of the embodiment of the present disclosure, not the whole embodiment. Based on the described embodiments of the present disclosure, all other embodiments obtained by ordinary skilled in the field without creative labor belong to the scope of protection of the present disclosure.

Compared with the embodiments shown in the accompanying drawings, the feasible embodiments within the protection scope of the present disclosure may have fewer components, other components not shown in the accompanying drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by people with ordinary skills in the field to which the present disclosure belongs. The terms “first”, “second” and similar terms used in the specification and claims of the patent application of the present disclosure do not indicate any order, quantity or importance, but are only used to distinguish different components. When the number of parts is not specified, the number of parts can be one or more; Similarly, similar words such as “a”, “an”, “the” and “said” do not necessarily mean quantity limitation. Similar words such as “including” or “containing” mean that the elements or objects appearing before the word cover the elements or objects listed after the word and their equivalents, without excluding other elements or objects. “Up”, “Down”, “Left” and “Right” are only used to indicate the relative orientation relationship when the equipment is used or the orientation relationship shown in the accompanying drawings. When the absolute position of the described object changes, the relative orientation relationship may also change accordingly.

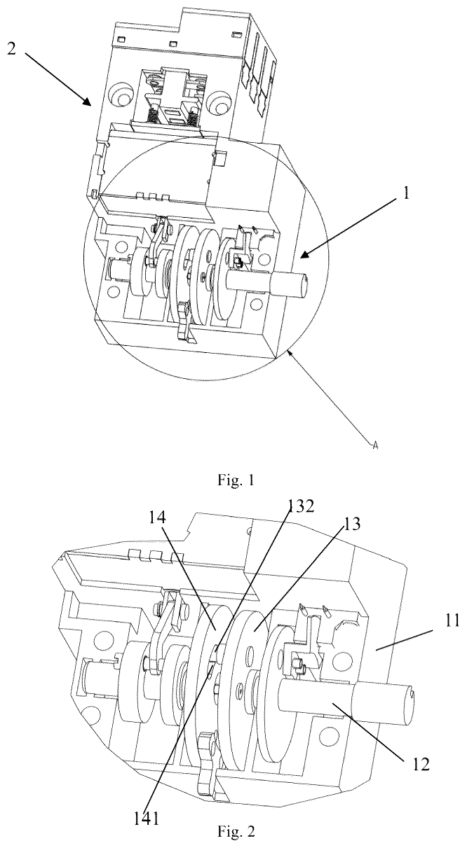

A bidirectional operation mechanism according to the present disclosure will be described below with reference to FIGS. 1 to 22. The operation mechanism of the application can be installed on a switching device, the switching device includes but not limited to a circuit breaker, a contactor, a solid state circuit breaker and a disconnector. In particular, the operation mechanism is a bidirectional operation mechanism, which is configured to be able to operate in both the forward direction and the reverse direction. When the operation mechanism operates in the forward direction, that is, when the operation mechanism opens and closes manually, the operation handle is manually operated to cause the switching device to close and open; when the operation mechanism operates in the reverse direction, that is, when the switching device itself is electrically operated to open and close, the opening and closing operation of the switching device can cause the operation handle to rotate, thus indicating the opening and closing.

FIG. 1 shows a perspective view of a switching device assembly according to a first embodiment of the present disclosure. The switching device assembly includes an operation mechanism 1 and a switching device 2, the operation mechanism includes a housing 11; an operation handle 12 rotatably installed on the housing, being capable of rotating between a closed position and an open position and indicating the closed position and the open position; a first driving member 13 rotatably installed on the housing, fixedly connected to the operation handle, and being capable of rotating together with the operation handle; a second driving member 14 rotatably installed on the housing, and operatively connected to the first driving member on the one hand and operatively connected to the switching device on the other hand, in particular to a driving component of the switching device through the transmission component.

As illustrated by FIG. 2, the first driving member 13 includes a body 131 and a protrusion 132 extending from the body 131 toward the second driving member, and the second driving member 14 includes a groove 141, the protrusion of the first driving member extends into the groove 141. The groove 141 includes a first end 142 and a second end 143. The first end 142 is located downstream of the second end 143 along the first direction, the first direction is a rotation direction of the second driving member when the switching device is switched from the closed state to the open state. FIG. 1 shows that the switching device is in the closed state and the operation handle is in the closed position.

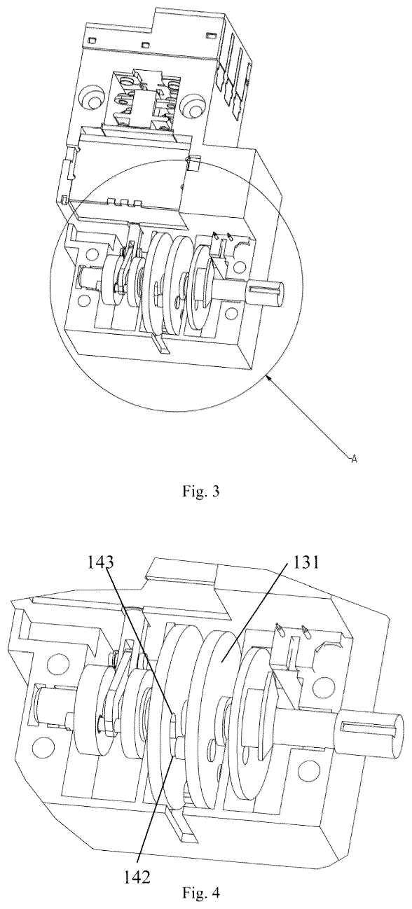

When the switching device performs an opening operation, the second driving member rotates in the first direction. Because the protrusion 132 abuts against the second end of the groove, the second driving member drives the first driving member to rotate in the first direction, so that the operation handle 12 rotates in the first direction toward the open position. One end of the operation handle spring 16 (see FIG. 6) is fixedly connected to the operation handle 12, and the other end of the operation handle spring 16 is fixed to the housing 11, the operation handle spring 16 is configured that the operation handle spring passes through the dead center position before the second driving member 14 rotates in place, so that the first driving member 13 continues to rotate in the first direction, so that the protrusion abuts against the first end of the groove and finally reaches the open position shown in FIGS. 3 and 4.

When the operation handle 12 rotates in the first direction from the closed position to the open position, the first driving member 13 rotates in the first direction by a predetermined angle (idle stroke), so that the protrusion abuts against the first end of the groove, which in turn drives the second driving member 14 to rotate in the first direction, which in turn switches the switching device from the closed state to the open state. Due to the existence of the predetermined angle, when the first driving member 13 starts to operate to the open position, a pre-trigger signal will be sent to the switching device via a sensor not shown. For example, such a sensor is in the form of a microswitch. Those skilled in the art can imagine any form of sensor to realize such a pre-trigger signal.

When the switching device performs a closing operation, the second driving member rotates in a second direction opposite to the first direction, and the first end of the groove abuts against the protrusion, so the second driving member directly drives the first driving member to rotate in the second direction. In this case, before the second driving member 14 rotates in place (when it nearly rotates in place), the operation handle spring passes through the dead center position, so that the first driving member 13 continues to rotate in the second direction, so that the protrusion abuts against the second end of the groove and finally reaches the closed position shown in FIGS. 1 and 2.

When the operation handle rotates in the second direction from the open position to the closed position, the first driving member rotates in the second direction by a predetermined angle (idle stroke), so that the protrusion abuts against the second end of the groove, and then the second driving member is driven to rotate in the second direction, so that the switching device is switched from the open state to the closed state. Due to the existence of the predetermined angle, when the first driving member 13 starts to operate to the closed position, a pre-trigger signal will be sent to the switching device via a sensor not shown. For example, such a sensor is in the form of a microswitch. Those skilled in the art can imagine any form of sensor to realize such a pre-trigger signal.

The operation process of the operation mechanism of the first embodiment has been described above, which can realize bidirectional operation. However, when the operation handle is blocked and not able to rotate, the switching device cannot perform tripping operation because the rotation of the second driving member in the first direction is blocked by the protrusion. In order to realize such free tripping, the application also designs a second embodiment and a third embodiment.

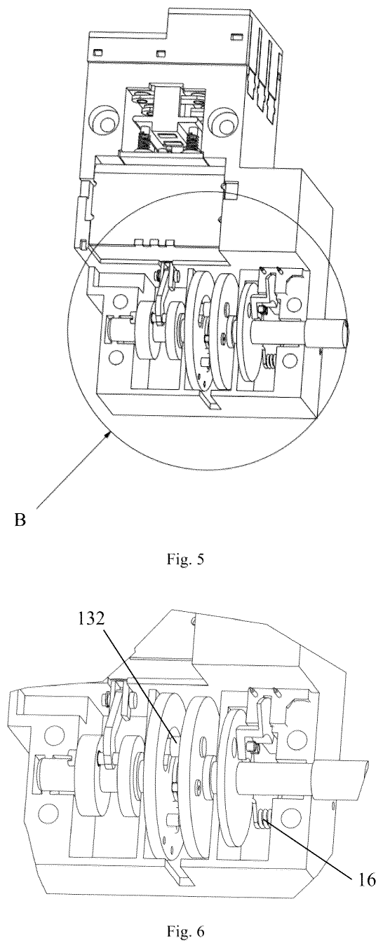

FIGS. 5 to 10 show a second embodiment according to the present disclosure.

FIGS. 5 and 6 show that the switching device is in the closed state, and the operation handle is in the closed position. In this case, the protrusion 132 of the first driving member 13 extends into the groove 141 of the second driving member 14 and is spaced apart from both the first end 142 and the second end 143. In addition, a sensor 17 is provided on the housing, and the function of the sensor 17 is described as follows.

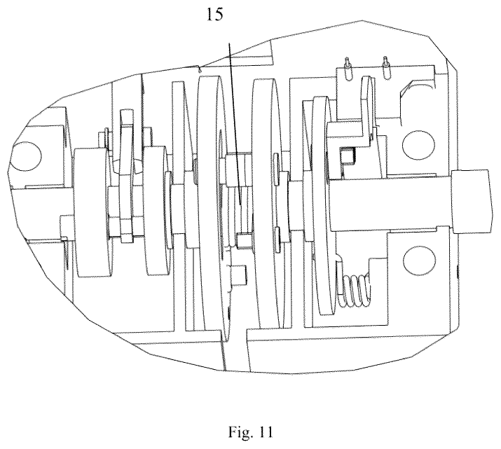

An elastic transmission member 15 is connected between the first driving member 13 and the second driving member 14, as illustrated by FIG. 11. The elastic transmission member 15 may be in the form of a torsion spring, with one end connected to the first driving member 13 and the other end connected to the second driving member 14.

### Bidirectional Opening Operation

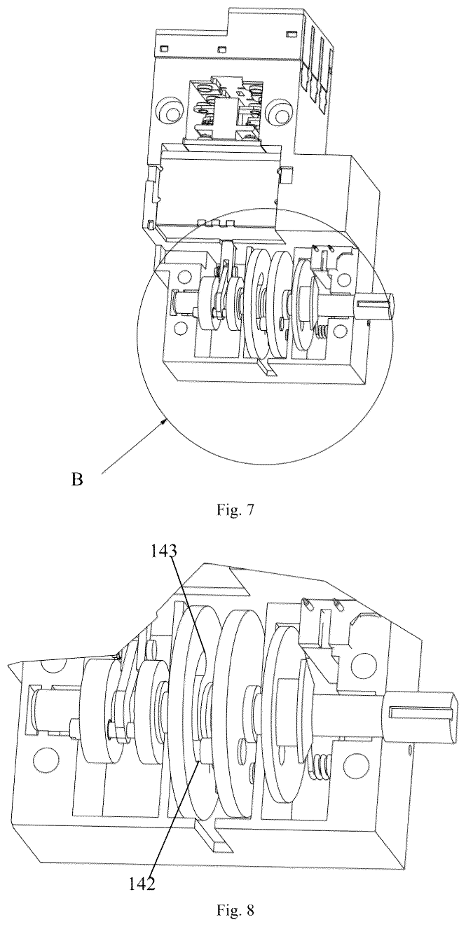

When the switching device performs an opening operation, the second driving member rotates in the first direction and drives the first driving member 13 to rotate in the first direction through the elastic transmission member 15, so that the operation handle rotates from the closed position to the open position. Before the second driving member rotates in place, the operation handle spring passes through the dead center position, so that the first driving member continues to rotate in the first direction, so that the protrusion abuts the first end of the groove, as illustrated by FIGS. 7 and 8.

When the operation handle rotates from the closed position to the open position under an action of an external force, the first driving member rotates by a predetermined angle in the first direction, so that the protrusion abuts against the first end of the groove, thereby driving the second driving member to rotate in the first direction. Due to the existence of a predetermined angle (i.e., idle stroke), when the first driving member 13 starts to operate to the open position, a pre-trigger signal will be sent to the switching device via a sensor not shown. For example, such a sensor is in the form of a microswitch. Those skilled in the art can imagine any form of sensor to send the pre-trigger signal. The key point is that the present disclosure sets the “idle stroke” to realize the pre-trigger, and the form of the sensor that sends the pre-trigger signal is not important.

### Bidirectional Closing Operation

When the switching device performs a closing operation, the second driving member rotates in the second direction, because the protrusion abuts against the first end of the groove, so the rotation of the second driving member in the second direction directly drives the first driving member to rotate in the second direction, so that the operation handle rotates from the open position to the closed position. Before the second driving member rotates in place, the operation handle spring passes through the dead center position, so that the first driving member continues to rotate in the second direction, and the protrusion is separated from the abutment with the first end of the groove.

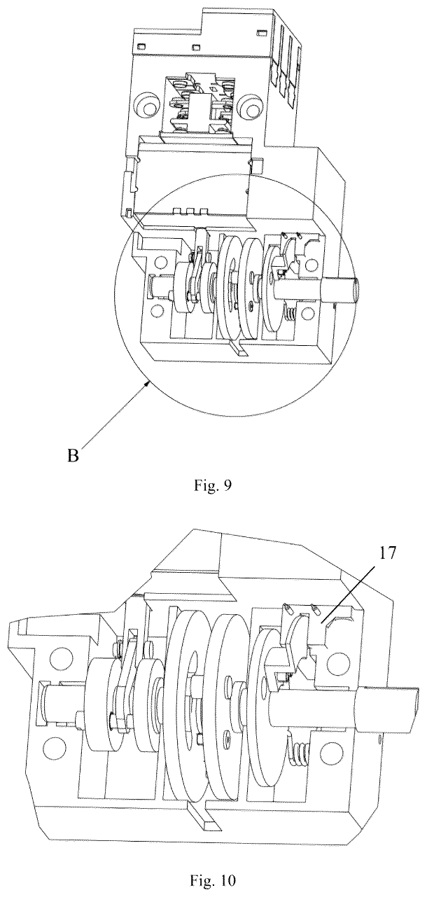

When the operation handle rotates from the open position to the closed position under an action of an external force, the first driving member rotates to the closed position in a second direction opposite to the first direction, as illustrated by FIGS. 9 and 10. In this case, a part of the operation handle triggers the sensor 17, so that the sensor sends an opening signal to an internal electromagnet of the switching device, thereby switching the switching device from the open state to the closed state and driving the second driving member to rotate in the second direction.

In other words, when the operation handle rotates from the open position to the closed position, in order to drive the second driving member to rotate in the second direction, the sensor is used to send the opening signal to the internal electromagnet of the switching device to realize the rotation of the second driving member.

The sensor can be one selected from the group consisting of a microswitch, a Hall sensor and a grating sensor. The relationship between the sensor and the internal electromagnet of the switching device is easy for those skilled in the art, and is not the focus of the present disclosure, so it will not be described in detail here.

### Free Tripping Operation

When the switching device performs a tripping operation under an action of an internal electromagnet, in response to that the operation handle is blocked and not able to rotate, the second driving member rotates in the first direction to switch the switching device from the closed state to the open state, as illustrated by FIGS. 9 and 10. During this process, the protrusion moves relatively in the groove, but it does not block the rotation of the second driving member. That is to say, the distance between the protrusion and the second end of the groove is designed such that the protrusion will not prevent the second driving member from rotating in the first direction to switch the switching device to the open state. Therefore, the function of free tripping is realized.

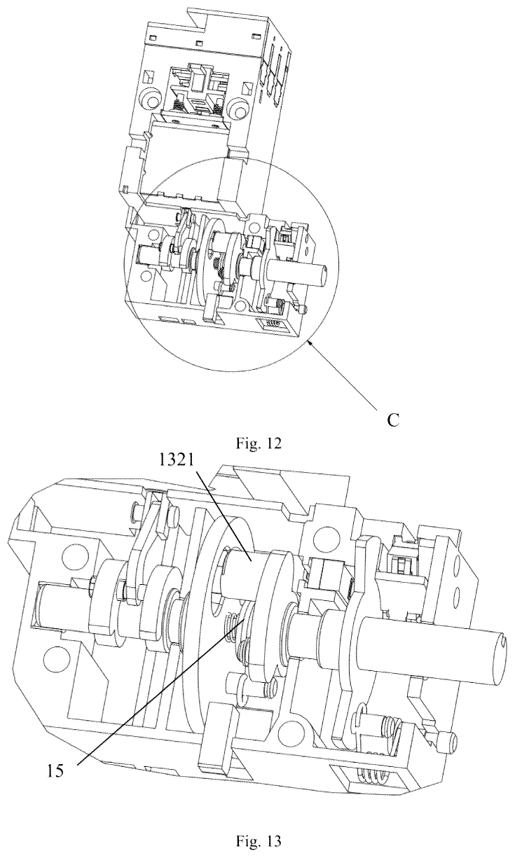

FIGS. 12 to 22 show a third embodiment according to the present disclosure.

The body 131 of the first driving member 13 is in the form of a disk, and the second driving member 14 is in the form of a disk. Of course, this also applies to the first and second embodiments.

In this third embodiment, the protrusion 132 includes a first protrusion part 1321 and a second protrusion part 1322, which are arranged in a longitudinal direction perpendicular to the plane where the disk of the second driving member is located, and a size of the first protrusion part in a direction perpendicular to the longitudinal direction is greater than that of the second protrusion part in the direction perpendicular to the longitudinal direction. In the case where both the first protrusion part and the second protrusion part are cylindrical, the diameter of the first protrusion part is larger than that of the second protrusion part.

The operation handle 12 is configured to be movable in the longitudinal direction between a first position and a second position; in the first position, the first protrusion part of the protrusion 132 is away from the second driving member 14, in the second position, the first protrusion part of the protrusion 132 is close to the second driving member 14.

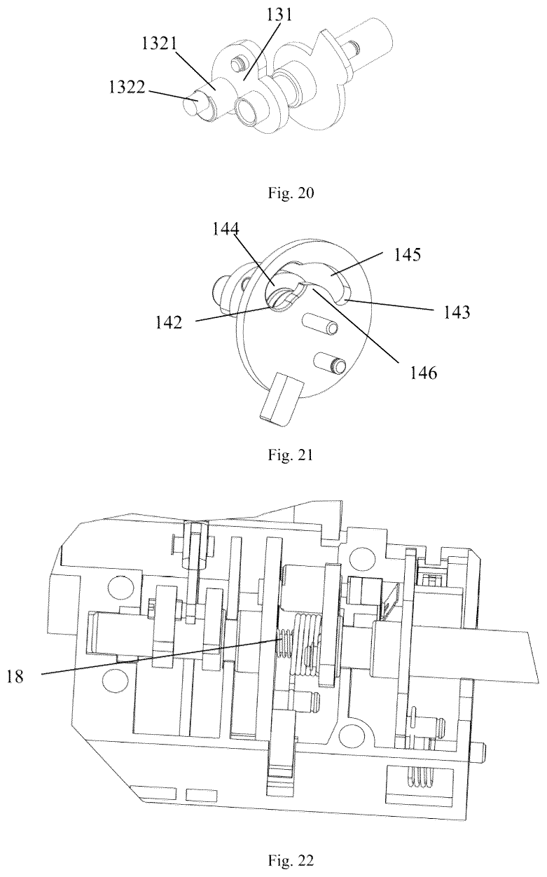

As illustrated by FIG. 20, the first protrusion part 1321 extends from the body 131 in the longitudinal direction, and the second protrusion part 1322 extends from the first protrusion part 1321 in the longitudinal direction. In this case, the operation handle is “pushed” from the first position to the second position. However, there may also be a case where the second protrusion part extends from the body in the longitudinal direction and the first protrusion part extends from the second protrusion part in the longitudinal direction, and the size of the first protrusion part in the direction perpendicular to the longitudinal direction is greater than that of the second protrusion part in the direction perpendicular to the longitudinal direction, in this case, the operation handle is “pulled” from the first position to the second position. In either case, in the first position, the first protrusion part of the protrusion 132 is away from the second driving member 14, and in the second position, the first protrusion part of the protrusion 132 is close to the second driving member 14.

As illustrated by FIG. 21, the groove 141 of the second driving member 14 includes a first groove part 144 and a second groove part 145 which are communicated with each other, the first groove part is located at a side of the first end, and the second groove part is located at a side of the second end, a size of the first groove part is configured to accommodate the first protrusion part and the second protrusion part, and a size of the second groove part is configured to accommodate the second protrusion part but not the first protrusion part, and a joint 146 is formed between the first groove part and the second groove part.

### Bidirectional Opening Operation

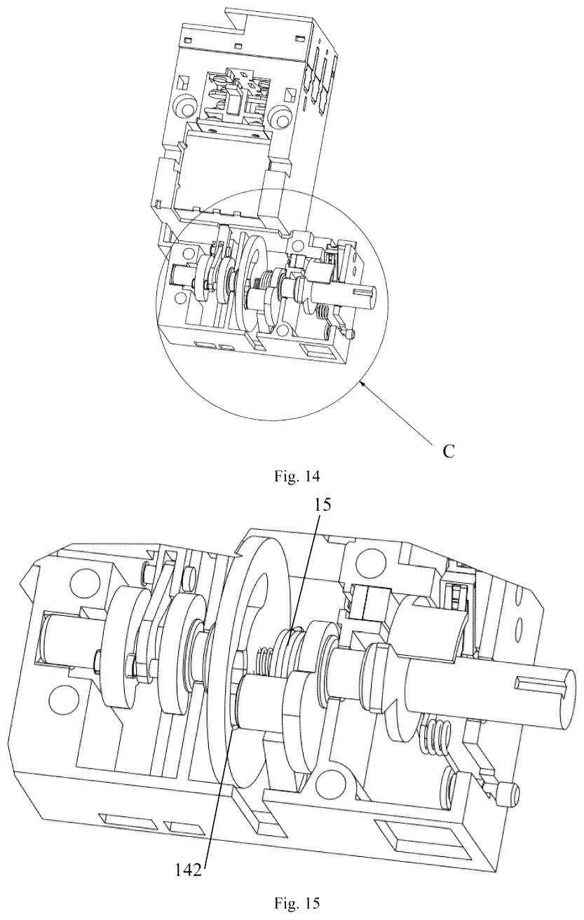

FIGS. 12 and 13 show that the switching device is in the closed state, and the operation handle is in the closed position and the first position. In this case, the second protrusion part 1322 extends into the first groove part 144. When the switching device performs an opening operation, the second driving member rotates in the first direction and drives the first driving member 13 to rotate in the first direction through the elastic transmission member 15, so that the operation handle rotates from the closed position to the open position. Before the second driving member rotates in place, the operation handle spring passes through the dead center position, so that the first driving member continues to rotate in the first direction, so that the second protrusion part 1322 abuts against the first end 141 of the groove (first groove part), as illustrated by FIGS. 14 and 15.

When the operation handle rotates from the closed position to the open position under an action of an external force, the first driving member rotates by a predetermined angle in the first direction, so that the second protrusion part abuts against the first end of the groove, thereby driving the second driving member to rotate in the first direction. Before the second driving member rotates in place, the operation handle spring passes through the dead center position, so that the first driving member continues to rotate in the first direction, and the second protrusion part abuts against the first end of the groove, as illustrated by FIGS. 14 and 15.

### Bidirectional Closing Operation

When the switching device performs a closing operation, the second driving member rotates in the second direction. Because the second protrusion part abuts against the first end of the first groove part, the rotation of the second driving member in the second direction directly drives the first driving member to rotate in the second direction, so that the operation handle rotates from the open position to the closed position. Before the second driving member rotates in place, the operation handle spring passes through the dead center position, so that the first driving member continues to rotate in the second direction, and the second protrusion part is separated from abutment with the first end of the groove (the first groove part).

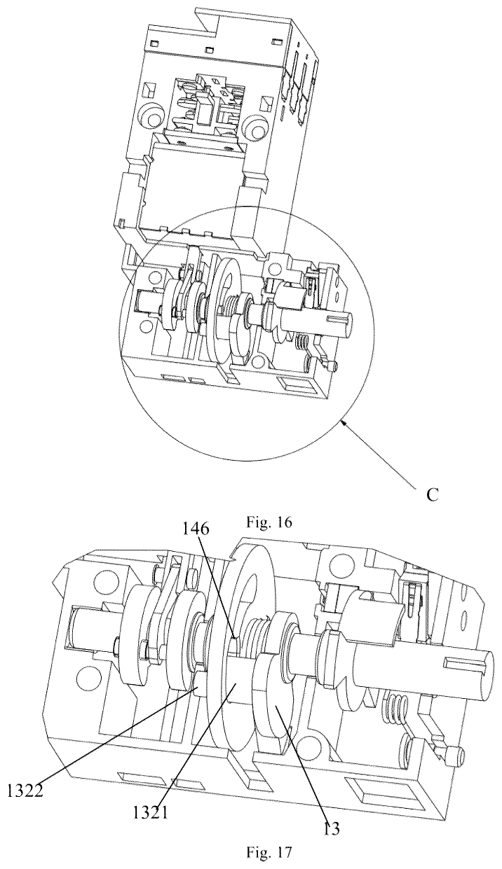

When the operation handle needs to rotate from the open position to the closed position under the action of external force, in order to realize that the operation handle drives the second driving member to rotate, the operation handle is moved from the first position to the second position, so that the first protrusion part 1321 extends into the first groove part, as illustrated by FIGS. 16 and 17.

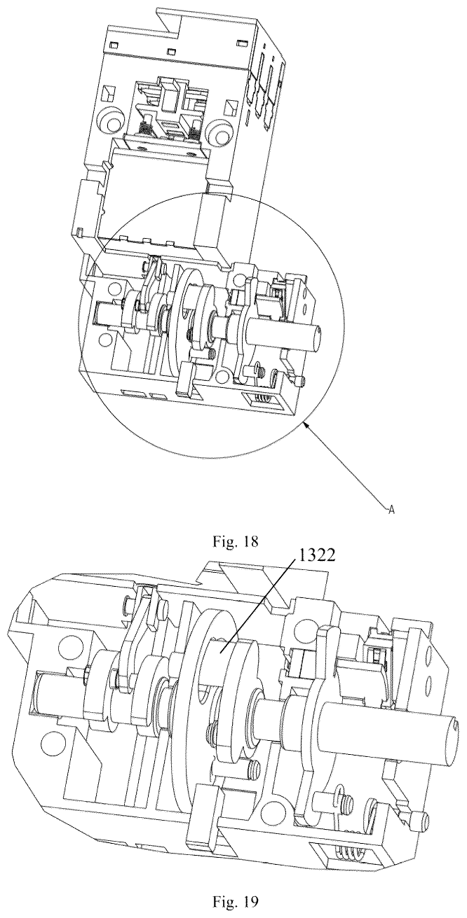

In this case, when the operation handle and the first driving member 13 rotate by a predetermined angle (idle stroke) in the second direction, the first protrusion part 1321 abuts against the joint 146, thereby pushing the second driving member to rotate in the second direction, so that the switching device is switched from the open state to the closed state. After the operation handle is rotated to the closed position, as illustrated by FIGS. 18 and 19, the operation handle is moved from the second position to the first position, so that the second protrusion part 1322 is in the first groove part.

In this embodiment, because the first protrusion part abuts against the joint 146 to drive the second driving member to rotate, the idle stroke of the rotation of the first protrusion part is the angle between the first end of the groove and the joint. However, this is not restrictive, and those skilled in the art will understand that the purpose of idle stroke is to pre-trigger, as long as there is no relative movement between the protrusion and the groove of the second driving member after the first driving member rotates by a predetermined angle.

In order to promote the operation handle to move from the second position to the first position, a return spring 18, such as a compression spring, is provided between the first driving member and the second driving member, as illustrated by FIG. 22. When the operation handle moves from the first position to the second position, the return spring is compressed and stores energy for returning the operation handle to the first position.

### Free Tripping Operation

When the switching device performs a free tripping operation under an action of an internal electromagnet, in response to that the operation handle is blocked and not able to rotate, the second driving member rotates in the first direction to switch the switching device from the closed state to the open state. In this process, the second protrusion part relatively moves from the first groove part to the second groove part, and does not block the rotation of the second driving member. Therefore, the function of free tripping is realized.

In the third embodiment, it is only needed to move the operation handle from the first position to the second position when the operation handle drives the second driving member to move from the open position to the closed position. In other operating conditions, the operation handle remains in the first position.

The application also provides a switching device assembly, which includes the operation mechanism and a switching device. The switching device can be any form of switch. The second driving member of the operation mechanism is connected to the switching device by any suitable transmission mechanism, so that the switching device can perform opening and closing operations. For such a transmission mechanism, those skilled in the art can design it according to their needs, and it is not the focus of this disclosure, so it will not be described here.

Through the operation mechanism of the present disclosure, the first driving member can drive the second driving member to realize the switching operation of the switching device, and the first driving member can also be driven by the second driving member to realize the accurate indication of the switching position by the operation handle, and in this process, the function of free tripping can be realized.

Although the present disclosure has been described in the specification and illustrated in the drawings on the basis of referring to various embodiments, those skilled in the art can understand that the above-mentioned embodiments are only preferred embodiments, and some technical features in the embodiments may not be necessary for solving specific technical problems, so these technical features may not be needed or omitted without affecting the solution of technical problems or the formation of technical solutions. Moreover, the features, elements and/or functions of one embodiment can be combined, cooperated or coordinated with those of one or more other embodiments as appropriate, unless the combination, cooperation or coordination is obviously impracticable.

1. An operation mechanism for a switching device, wherein the operation mechanism is installed on the switching device, which is characterized in that the operation mechanism comprises:
a housing;
an operation handle, rotatably installed on the housing, being capable of rotating between a closed position and an open position and indicating the closed position and the open position;
a first driving member, rotatably installed on the housing, fixedly connected to the operation handle and being capable of rotating together with the operation handle;
a second driving member, rotatably installed on the housing, operatively connected to the first driving member and the switching device,
wherein the first driving member comprises a body and a protrusion extending from the body toward the second driving member, and the second driving member comprises a groove, the protrusion of the first driving member extends into the groove,
the groove comprises a first end and a second end, and the first end of the groove is located downstream of the second end relative to a first direction, the first direction corresponds to a rotation direction of the second driving member when the switching device is switched from a closed state to an open state,
when the switching device performs a tripping operation under an action of an internal electromagnet, in response to that the operation handle is blocked and not able to rotate, the second driving member rotates in the first direction to switch the switching device from the closed state to the open state, the protrusion move relatively in the groove, and a distance between the protrusion and the second end of the groove is configured such that the protrusion will not prevent the second driving member from rotating in the first direction to switch the switching device to the open state.

2. The operation mechanism according to claim 1, which is characterized in that,
in the closed state of the switching device, when the operation handle is in the closed position, the protrusion of the first driving member is configured not to abut against the first end and the second end of the groove,
the operation mechanism further comprises an elastic transmission member connected between the first driving member and the second driving member.

3. The operation mechanism according to claim 2, which is characterized in that, in the closed state of the switching device, when the operation handle is in the closed position, when the operation handle rotates from the closed position to the open position under an action of an external force, the first driving member rotates by a predetermined angle in the first direction, so that the protrusion abuts against the first end of the groove, thereby driving the second driving member to rotate in the first direction.

4. The operation mechanism according to claim 2, which is characterized in that, when the switching device performing an opening operation, the second driving member rotates in the first direction, and a rotating force is transmitted to the first driving member through the elastic transmission member, so that the first driving member also rotates in the first direction, and the operation handle rotates in the first direction toward the open position.

5. The operation mechanism according to claim 4, which is characterized in that, further comprising an operation handle spring, one end of the operation handle spring is operatively connected to the operation handle and the other end of the operation handle spring is fixed to the housing, and the operation handle spring is configured to pass through a dead center position before the second driving member rotates in place when the operation handle is driven by the second driving member to rotate from the closed position to the open position, so that the first driving member continues to rotate in the first direction, so as to allow the protrusion to abut against the first end of the groove.

6. The operation mechanism according to claim 2, which is characterized in that, in open state of the switching device, when the operation handle is in the open position, the protrusion abuts against the first end, and when the switching device performs a closing operation, the second driving member rotates in a second direction opposite to the first direction, and the first end pushes the protrusion and further pushes the first driving member to rotate in the second direction, so that the operation handle rotates in the second direction towards the closed position,
when the operation handle is driven by the second driving member to rotate from the open position to the closed position, before the second driving member rotates in place, the operation handle spring passes through a dead center position, so that the first driving member continues to rotate in the second direction, and the protrusion is separated from abutment with the first end of the groove.

7. The operation mechanism according to claim 1, which is characterized in that, further comprising a sensor arranged on the housing,
in the open state of the switching device, when the operation handle is in the open position, when the operation handle rotates from the open position to the closed position under an action of an external force, the first driving member rotates to the closed position in a second direction opposite to the first direction, a part of the operation handle triggers the sensor, so that the sensor sends a closing signal to the internal electromagnet of the switching device, thereby switching the switching device from the open state to the closed state.

8. The operation mechanism according to claim 1, which is characterized in that,
the body of the first driving member is in the form of a disk,
the second driving member is in the form of a disk,
the protrusion comprises a first protrusion part and a second protrusion part, the first protrusion part and the second protrusion part are arranged along a longitudinal direction, and a size of the first protrusion part in a direction perpendicular to the longitudinal direction is greater than a size of the second protrusion part in the direction perpendicular to the longitudinal direction,
the operation handle is configured to be movable in the longitudinal direction between a first position and a second position; in the first position, the first protrusion part of the first driving member is away from the groove of the second driving member, in the second position, the first protrusion part of the first driving member is close to the groove of the second driving member.

9. The operation mechanism according to claim 8, which is characterized in that, the groove comprises a first groove part and a second groove part which are communicated with each other, the first groove part is located at a side of the first end and the second groove part is located at a side of the second end, a size of the first groove part is configured to accommodate the first protrusion part and the second protrusion part, a size of the second groove part is configured to accommodate the second protrusion part but not the first protrusion part, and a joint is formed between the first groove part and the second groove part.
in the first position of the operation handle, the second protrusion part can be accommodated in the first groove part and the second groove part,
in the second position of the operation handle, the first protrusion part can be accommodated in the first groove part.

10. The operation mechanism according to claim 9, which is characterized in that, in the closed state of the switching device, when the operation handle is in the closed position, the operation handle is in the first position, and the second protrusion part is accommodated in the first groove part and spaced apart from the first end and the second end,
when the switching device performs a tripping operation under the action of the internal electromagnet, in response to that the operation handle is blocked and not able to rotate, the second driving member rotates in the first direction to switch the switching device from the closed state to the open state, and the second protrusion part of the first driving member relatively moves from the first groove part to the second groove part.

11. The operation mechanism according to claim 10, which is characterized in that, in the open state of the switching device, when the operation handle is in the open position, the second protrusion part abuts against the first end of the groove, and when the operation handle rotates from the open position to the closed position under an action of an external force, the operation handle moves from the first position to the second position, so that the first protrusion part is accommodated in the first groove part, with a rotation of the first driving member in the second direction, the first protrusion part abuts against the joint between the first groove part and the second groove part, so as to push the second driving member to rotate in the second direction, so as to switch the switching device from the open state to the closed state, after the operation handle rotates to the closed position, the operation handle moves from the second position to the first position.

12. The operation mechanism according to claim 11, which is characterized in that, further comprising a return spring arranged between the first driving member and the second driving member, and when the operation handle moves from the first position to the second position, the return spring is compressed to store energy, so as to return the operation handle from the second position to the first position.

13. The operation mechanism according to claim 7, which is characterized in that, the sensor is any one selected from the group consisting of a microswitch, a Hall sensor and a grating sensor.

14. An operation mechanism for a switching device, wherein the operation mechanism is installed on the switching device, which is characterized in that, the operation mechanism comprises:
a housing;
an operation handle, rotatably installed on the housing, being capable of rotating between a closed position and an open position and indicating the closed position and the open position;
a first driving member, rotatably installed on the housing, fixedly connected to the operation handle and being capable of rotating together with the operation handle;
a second driving member, rotatably installed on the housing, operatively connected to the first driving member and the switching device,
wherein the first driving member comprises a body and a protrusion extending from the body toward the second driving member, and the second driving member comprises a groove, the protrusion of the first driving member extends into the groove,
the groove comprises a first end and a second end, and the first end of the groove is located downstream of the second end relative to a first direction, the first direction corresponds to a rotation direction of the second driving member when the switching device is switched from the closed state to the open state,
in a closed state of the switching device, when the operation handle is in the closed position, the protrusion of the first driving member is arranged to be spaced apart from the first end of the groove,
in a closed state of the switching device, when the operation handle is in the closed position when the operation handle rotates from the closed position to the open position under an action of an external force, the first driving member rotates by a predetermined angle in the first direction, so that the protrusion abuts against the first end of the groove, and then the second driving member is driven to rotate in the first direction, so as to switch the switching device from the closed state to the open state.

15. The operation mechanism according to claim 14, which is characterized in that, in the open state of the switching device, when the operation handle is in the open position, the protrusion of the first driving member is arranged to be spaced apart from the second end of the groove,
in the open state of the switching device, when the operation handle is in the open position, when the operation handle rotates from the open position to the closed position under the action of the external force, the first driving member rotates by a predetermined angle in a second direction opposite to the first direction, so that the protrusion is able to drive the second driving member to rotate in the second direction, so as to switch the switching device from the open state to the closed state.

16. A switching device assembly, which is characterized in that, the switching device assembly comprises a switching device and the operation mechanism according to claim 1, and the operation mechanism is installed on the switching device.
